(19) United States
(12) Patent Application Publication
(10) Pub. No.: US 2004/0088291 A1
(43) Pub. Date: May 6, 2004

(54) Retrieval condition setting method and retrieval condition setting apparatus

(75) Inventors: Hiroshi Matsuzaki, Hachioji-shi (JP); Yukihito Furuhashi, Hachioji-shi (JP); Hikihiko Terashima, Hachioji-shi (JP); Takao Shibasaki, Tokyo (JP)

Correspondence Address: SCULLY SCOTT MURPHY & PRESSER, PC, 400 GARDEN CITY PLAZA, GARDEN CITY, NY, 11530

(73) Assignee: Olympus Corporation, Tokyo (JP)

(21) Appl. No.: 10/695,170

(22) Filed: Oct. 28, 2003

(30) Foreign Application Priority Data
Oct. 31, 2002 (JP) 2002-317996

(51) Int. Cl. G06F 7/00

(52) U.S. Cl. 707/3

(57) ABSTRACT

When retrieving similar multimedia object data from a multimedia object database on the basis of the retrieval condition set by a user, a retrieval condition setting area for retrieval condition setting is displayed as an independent area. Then, a retrieval condition is set on the basis of multimedia object data which has been set in or which has been input to the retrieval condition setting area.

### CROSS-REFERENCE TO RELATED APPLICATIONS

This application is based upon and claims the benefit of priority from the prior Japanese Patent Application No. 2002-317996, filed Oct. 31, 2002, the entire contents of which are incorporated herein by reference.

### BACKGROUND OF THE INVENTION

1. Field of the Invention

The present invention relates to a retrieval condition setting method and a retrieval condition setting apparatus for setting a retrieval condition in order to retrieve a similar multimedia object on the basis of feature values of multimedia object data, which are digital data, such as three-dimensional data representing a shape of an object, two-dimensional image data, dynamic image data, video data, audio data or music data.

2. Description of the Related Art

In recent years, digital information is used in all scenes. With respect to not only text information but also data representing three-dimensional object data, not to mention two-dimensional data such as image data or video data, the digital information is vigorously used in digital archives formed by converting commodities into three-dimensional object data and converting archeological legacies and objects of art, besides conventional CAD data. These data go on increasing, and demands for efficient data management and efficient retrieval of data requested by users are increasing. In order to accede to such demands, various information retrieval techniques have been proposed. As regards the similar object retrieval technique as well, a large number of methods of calculating feature values owned by objects and conducting retrieval according to the characteristic quantities have been proposed. As regards multimedia object data retrieval apparatuses, which especially become the subject of the present invention as well, several techniques have heretofore been proposed.

In some methods for setting a retrieval condition to be used to conduct retrieval, multimedia object data (inquiry object data) similar to a multimedia object that the user wants to retrieve is specified, and similar multimedia object data retrieval is conducted on the basis of the specified multimedia object. For example, in the case where retrieval of a two-dimensional image is conducted, some methods include the steps of calculating a plurality of image features, generating a feature vector from the features, comparing the generated feature vector with a feature vector of an image registered in an image database that becomes the subject of retrieval, and thereby retrieving a similar image. This is widely studied as retrieval on the basis of an image content. As a method for specifying an inquiry image when conducting retrieval, a method of displaying a list of images registered in a database and specifying an image similar to an image to be retrieved, from among the images in the list has been adopted.

Furthermore, a method of selecting a plurality of inquiry images and setting a retrieval condition on the basis of the images has been proposed in, for example, Jpn. Pat. Appln. KOKAI Publication No. 9-101970. In a method described therein, nine images are displayed on the same screen in a 3 by 3 array form as a retrieval result, a preceding or subsequent image is displayed by operating a scroll bar. Then, the user selects a plurality of images similar to a desired image and a plurality of images dissimilar to the desired image, from among a plurality of candidate images displayed at this time. On the basis of differences in feature values among a plurality of selected images, weight coefficients for respective feature values in similarity calculation are set. In this method, a decision whether images are similar or dissimilar is conducted by clicking with a pointing device, such as a mouse, on a retrieval result display area. Retrieval condition setting is conducted by indicating a mark 0 on a similar image and indicating a mark X on a dissimilar image.

### BRIEF SUMMARY OF THE INVENTION

A method according to a first aspect of the present invention is a method for setting a retrieval condition when retrieving similar multimedia object data from a multimedia object database on the basis of the retrieval condition set by a user. In the method, a retrieval condition setting area for retrieval condition setting as an independent area is displayed. A retrieval condition is set on the basis of one of multimedia object data which has been set in the retrieval condition setting area and multimedia object data which has been input to the retrieval condition setting area.

An apparatus according to a second aspect of the present invention is an apparatus for setting a retrieval condition when retrieving similar multimedia object data from various multimedia object databases on the basis of the retrieval condition set by a user. The apparatus comprises: a display device having a display screen in which a retrieval condition setting area for retrieval condition setting is displayed as an independent area; an input unit configured to one of set and input multimedia object data in and to the retrieval condition setting area displayed on the display screen of the display device; and a retrieval condition setting unit configured to set a retrieval condition on the basis of multimedia object data one of set in and input to the retrieval condition setting area by the input unit.

An apparatus according to a third aspect of the present invention is an apparatus for setting a retrieval condition when retrieving similar multimedia object data from various multimedia object databases on the basis of the retrieval condition set by a user. The apparatus comprises: a display device having a display screen in which a retrieval condition setting area for retrieval condition setting is displayed as an independent area; input means for one of setting and inputting multimedia object data in and to the retrieval condition setting area displayed on the display screen of the display device; and retrieval condition setting means for setting a retrieval condition on the basis of multimedia object data one of set in and input to the retrieval condition setting area by the input means.

Herein, in the specification, the term “multimedia object data” means digital data, such as three-dimensional data representing object shapes, two-dimensional image data, dynamic image data, video data, audio data or music data. In addition, the term “multimedia object data” also means digital data, such as three-dimensional data, . . . , music data, including text data.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a configuration of a multimedia object data retrieval apparatus to which a retrieval condition setting method according to a first embodiment of the present invention is applied;

FIG. 2 is a diagram showing a display form in a retrieval condition setting area on a display screen of a display apparatus in the first embodiment;

FIG. 3 is a diagram showing another display form in a retrieval-condition setting area on a display screen of the display apparatus in the first embodiment;

FIG. 4 is a diagram showing an example of a retrieval condition setting area in the first embodiment;

FIG. 5 is a diagram showing an example of an object data list display area set in a display screen of a display apparatus in the first embodiment;

FIG. 6 is a diagram showing an example of a retrieval condition setting area in a second embodiment of the present invention;

FIG. 7 is a diagram showing an inquiry object data display area in the second embodiment;

FIG. 8 is a diagram showing another example of a retrieval condition setting area in the second embodiment;

FIG. 9 is a diagram showing an example of a retrieval condition setting area in a third embodiment of the present invention;

FIG. 10 is a diagram showing an example of a retrieval condition setting area in a fourth embodiment of the present invention;

FIG. 11 is a diagram showing another example of the retrieval condition setting area in the fourth embodiment; and

FIG. 12 is a diagram showing a configuration of a multimedia object data retrieval apparatus to which a retrieval condition setting method according to a fifth embodiment of the present invention is applied.

### DETAILED DESCRIPTION OF THE INVENTION

Hereafter, embodiments of the present invention will be described with reference to the drawings.

[First Embodiment]

As shown in FIG. 1, a multimedia object data retrieval apparatus to which a retrieval condition setting method according to a first embodiment of the present invention has been applied includes, as system configuration components, an arithmetic operation device 1, input devices 2 for data input and operation input such as a keyboard, a mouse or a tablet, and a display device 3 serving as an object data display unit such as a CRT, a liquid crystal display or a three-dimensional display device. The arithmetic operation device 1 includes an object data input unit 11, a feature values calculation unit 12, a database registration unit 13 and a similarity calculation unit 14. Multimedia object data from the input devices 2 is input by the object data input unit 11. The feature values calculation unit 12 calculates feature values of multimedia object data input by the object data input unit 11. The database registration unit 13 registers the feature value calculated by the feature values calculation unit 12 in a multimedia object database. The similarity calculation unit 14 retrieves multimedia objects similar to multimedia object data preset as a retrieval condition from the multimedia object database. In this case, although details will be described later, multimedia object data is set as the retrieval condition by specifying the multimedia object data with the input devices 2 from among multimedia object data registered in the multimedia object database. In other words, the similarity calculation unit 14 compares feature values of the multimedia object data set as the retrieval condition, which is calculated by the feature values calculation unit 12, with the feature values of each multimedia object data, which is registered in the multimedia object database, calculates a similarity between them, and thereby retrieves similar multimedia object data. Since the present invention relates to a retrieval condition setting method, description concerning details of the actual retrieval operation will be omitted.

As shown in FIG. 1, the multimedia object database is distributively disposed as an original data database 4A in which original multimedia object data is registered and a feature values database 4B for registering calculated feature values. In the present embodiment, the multimedia object database is described as a form of a distributed database. However, it is not always necessary for the multimedia object database to be a distributed database, but it is also possible to form the multimedia object database of a single database.

As object data input to the object data input unit 11, arbitrary multimedia object data such as two-dimensional image data, three-dimensional shape data, audio data or music data can be used.

The user can browse a list of multimedia objects displayed on the display device 3 by using an object browsing function and select an arbitrary multimedia object as a retrieval subject from the original data database 4A or an external multimedia object database. In the description of the present embodiment, the list is displayed on the display device 3 included in the multimedia object data retrieval apparatus. However, the retrieval processing can also be conducted via the Internet. In other words, it is also possible to adopt a form in which the retrieval processing is conducted in an Internet server and the retrieval condition setting, data browsing in the object database and retrieval result display are conducted in a client processing apparatus.

As for the multimedia object data input to the object data input unit 11, it is also possible to select a multimedia object from an external object database 5 or from among existing multimedia objects opened to the public on an external Web site 6, besides the specified original data database 4A. Alternatively, it is possible to use arbitrary digital data generated by another object generation unit 7 serving as an external object data input unit such as a two-dimensional image picked up by the user, a CAD, three-dimensional object data created arbitrarily by using a three-dimensional object generation tool, or object data input by using a three-dimensional object image pickup and input device such as a range finder. As regards the data form as well, an arbitrary data form can be handled.

When conducting-retrieval operation, objects in the multimedia object database are catalog-displayed as a list. Then, retrieval condition setting is conducted by selecting multimedia object data (inquiry multimedia object data) for which similar multimedia object data should be retrieved, from the list. According to a feature of the present embodiment, a movable area different from a catalog display area for displaying a list of multimedia objects in the multimedia object database is provided in the display screen of the display device 3. The user can freely arrange the respective areas in the display screen of the display device 3. In addition, since each function is displayed collectively in an independent area, its use is facilitated.

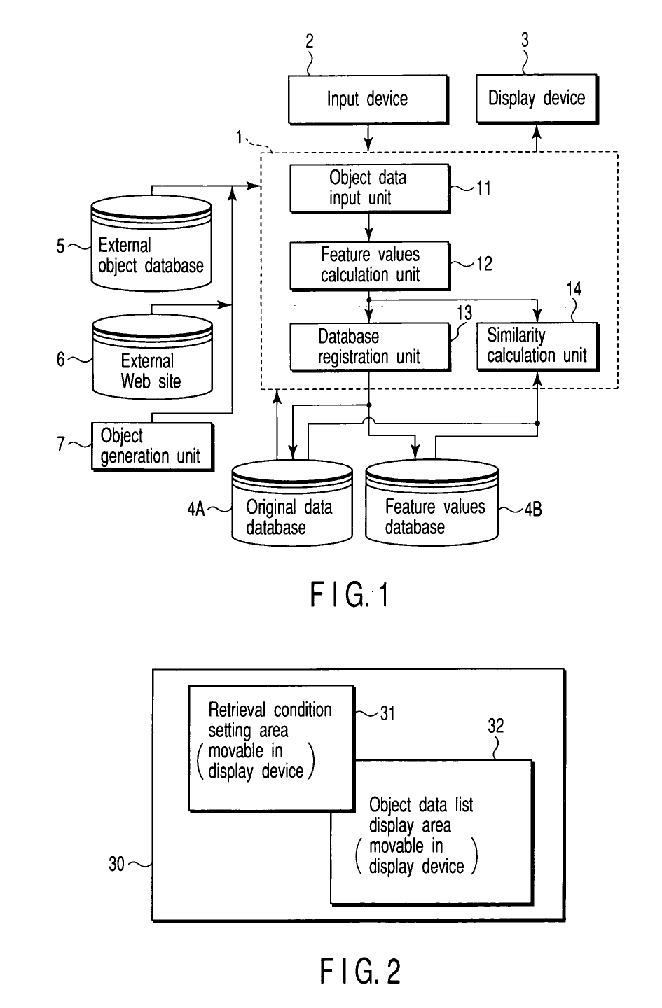

In other words, as shown in FIG. 2, a retrieval condition setting area 31 for setting a retrieval condition and an object data list display area 32 serving as a catalog display area capable of displaying a multimedia object list of a multimedia object database or the like are displayed on a display screen 30 of the display device 3. The areas 31 and 32 are set as movable areas in the display screen 30 of the display device 3.

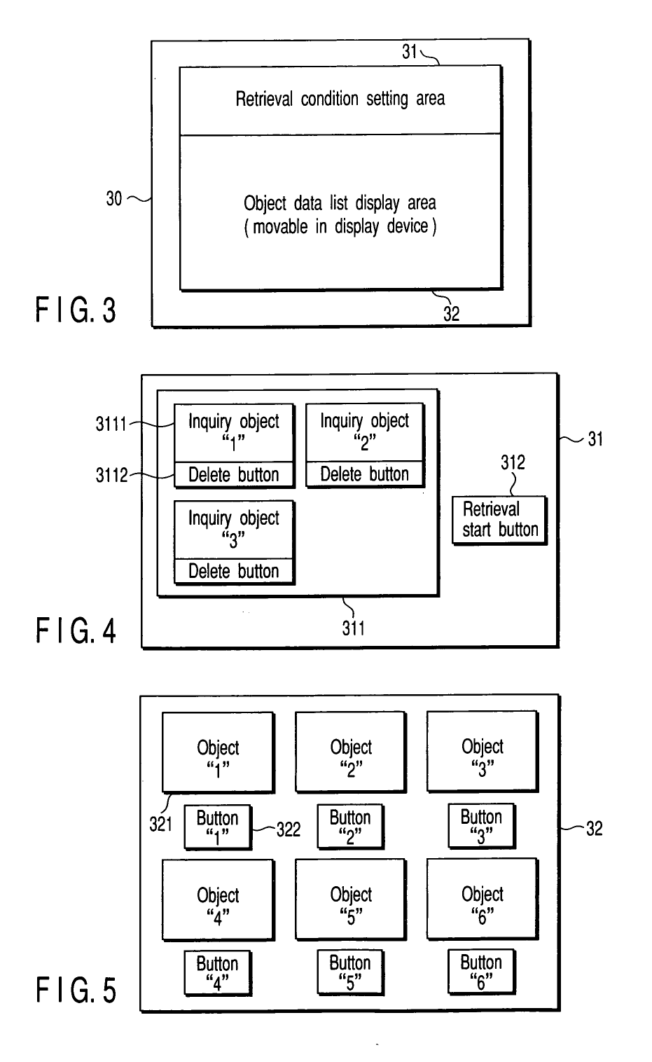

The retrieval condition setting area 31 in the display screen 30 of the display device 3 may have a display form as shown in FIG. 3. In this example, the retrieval condition setting area 31 and the object data list display area 32 are set so as to be adjacent to each other. In the case of such a layout as well, respective functions are displayed collectively in independent areas, its use is facilitated.

The retrieval condition setting area 31 as shown in FIG. 2 or 3 is called retrieval tray as well. For example, as shown in FIG. 4, an inquiry object data display area 311 and a retrieval start button 312 are arranged in the retrieval condition setting area 31.

In other words, multimedia object data input from the object data input unit 11 is first displayed in the inquiry object data display area 311 as an inquiry object 3111. The multimedia object data displayed as the inquiry object 3111 is data that is obtained by conducting processing on input original multimedia object data and outputting its result and that is associated with the original multimedia object data. In other words, if the input original data is two-dimensional image data, then the original image as it is, a suitably contracted two-dimensional image, text information representing an attribute of an image, or the like can be used. If the input original data is a three-dimensional shape data, it is possible to directly display the three-dimensional shape data, or conduct display so as to be able to display three-dimensional data obtained by simplifying the original three-dimensional shape data, at an arbitrary viewpoint in the display area of each inquiry object 3111. Alternatively, a two-dimensional image rendered in a suitable viewpoint direction, text information representing an attribute of the three-dimensional shape data, or the like can be displayed. Here, one or more inquiry objects 3111 can be set. In the example shown in FIG. 4, a state in which three inquiry objects “1” to “3” are set is illustrated.

By clicking the retrieval start button 312 with a pointing device such as a mouse, which is one of the input devices 2, a retrieval condition is set by statistical processing conducted on the feature values of a preset number of multimedia object data and feature values of the multimedia object data in the multimedia object database, and retrieval is started. As for the concrete retrieval condition setting method, a weight coefficient can be set on the basis of a ratio of dispersion between elements of a feature values vector owned by respective multimedia object data to dispersion between elements of a feature values vector owned by a plurality of multimedia objects in the multimedia object database. At the time of retrieval condition setting, it is possible not only to add a specified multimedia object, but also to delete multimedia object data already added to the retrieval condition setting area 31. As for this, the already added multimedia object is deleted from the retrieval condition setting area 31 by clicking a deletion button 3112, which is set for each inquiry object 3111 as shown in FIG. 4.

The object data list display area 32, which is set in the display screen 30 of the display device 3 as shown in FIG. 2 or 3, displays contents of multimedia object data registered in the multimedia object database or the like in a list form as a catalog. In FIG. 5, six objects 321 including objects “1” to “6” are displayed as an example. As a matter of course, the number of displayed objects 321 can be arbitrarily set. In addition, by scrolling the screen or conducting page switching in the object data list display area 32, more multimedia object data than the number displayed on one page can be browsed. As for the database to be used, it is possible to use not only the internal multimedia object database (the original data database 4A) registered in the system but also to use the external object database (the external object database 5) opened to the public or multimedia object data opened to the public on the Internet (the external Web site 6).

As shown in FIG. 5, the object data list display area 32 is divided in a matrix form, and individual multimedia object data or associated images are displayed as objects 321. A control part such as a button for indicating a selection state of the object 321 or setting into the retrieval condition setting area 31 is displayed near each object. A plurality of control parts can also be set. It is possible to assign the control parts to buttons for conducting arbitrary operations, such as setting buttons into the retrieval condition setting area 31 and detailed information display button of the object 321. If a button 322 preset as setting buttons into the retrieval condition setting area 31 is clicked, then it is possible to set multimedia object data corresponding to the object 321 into the retrieval condition setting area 31. In addition, it is also possible to conduct setting in the retrieval condition setting area 31 by clicking the object 321 itself. Furthermore, it is also possible to implement setting into the retrieval condition setting area 31 by continuing to click the object 321 with a pointing device such as a mouse and moving it to (the inquiry object data display area 311 in) the retrieval condition setting area 31 (by conducting the so-called “drag and drop” operation).

In addition, as the multimedia object data that can be set in the retrieval condition setting area 31, it is also possible to transmit a multimedia object data file owned by the user to the system and set it. Furthermore, it is also possible to set multimedia object data generated by using the object generation unit 7 connected to the multimedia object data retrieval apparatus, in the retrieval condition setting area 31.

Furthermore, the object data list display area 32 shown in FIG. 5 can be used also as a retrieval result list display area for displaying retrieval results. In this case, it is also possible for the user to newly set the inquiry object 3111 for re-retrieval from among the retrieval results in the retrieval condition setting area 31 and conduct retrieval. In the case where the object data list display area 32 is thus used as the retrieval result list display area, in addition, the retrieval results can be rearranged according to feature values specified by the user. Therefore, results of actually conducted retrieval or results obtained by rearranging the retrieval results can be set as the inquiry object 3111. At this time, since it is a retrieval result intended by the user or a result obtained by rearrangement according to the magnitude of the feature values specified by the user, the possibility that it has become an object that is suitable as the inquiry object 3111 is high. By setting as many high-ranking object data in the retrieval result or rearranged result as a preset number in the retrieval condition setting area 31, it becomes possible for the user to preset a further more suitable inquiry object 3111 more simply as compared with searching of the object list in the multimedia object database that has been arranged in a state in which there is no regularity.

According to the first embodiment heretofore described, the retrieval condition setting area 31 is disposed in a partial area in the display screen 30 of the display device 3, and it can be moved in the display screen 30 independently. The user can set and ascertain a retrieval condition by perusing only information in the retrieval condition setting area 31, and in addition, the user can execute retrieval by using the retrieval start button 312. When conducting retrieval condition setting, therefore, it becomes easier for the user to understand the retrieval condition that has been set. In addition, since the retrieval condition setting area 31 can be moved to an arbitrary position in the display screen 30, it is possible for the user to dispose the retrieval condition setting area 31 in a position that is easy to use and conduct retrieval operation. Furthermore, a plurality of inquiry objects 3111 can be set in the inquiry object data display area 311 in the retrieval condition setting area 31. In addition, it is also possible to delete an inquiry object that has been already set as the retrieval condition in the inquiry object data display area 311.

Furthermore, according to the first embodiment, a display area (the object data list display area 32) capable of displaying a list of multimedia object data registered in the multimedia object database is provided. As a result, the user can set a retrieval condition by conducting operation of selecting multimedia object data similar to multimedia object data to be retrieved from the list, resulting in simple use. In addition, in the object data list display area 32, a setting button 322 is disposed near the display area of the object 321, and it is displayed that the object 321 can be set as an inquiry image by clicking the button 322. When setting an inquiry object in the retrieval condition setting area 31, therefore, the user can simply conducting setting by conducting the click operation only once. Furthermore, when setting an inquiry object in the retrieval condition setting area 31, an object 321 can be set as an inquiry image by clicking the displayed object 321 itself and thereby specifying it. Owing to such an operation method, the user can simply conduct setting by conducting click operation only once. In addition, when setting an inquiry object in the retrieval condition setting area 31, a displayed object 321 itself is clicked with a mouse and is displaced into the retrieval condition setting area 31 while being clicked, and thereby the object 321 can be set as an inquiry object. Owing to the adoption of such an operation method, the user can conduct setting by conducting an operation of actually grasping an object 321 and moving it to the retrieval condition setting area 31, which is similar to the actual operation, resulting in a simple and intelligible setting method.

Furthermore, according to the first embodiment, object data is picked up in image or created by using, for example, a two-dimensional image input device, such as a camera or a scanner, a three-dimensional reconstruction apparatus for obtaining a stereo-image, or a three-dimensional shape image pickup and input device such as a laser range finder, as an object data input unit. In the case where a multimedia object that the user wants to retrieve does not exist in data previously registered in the multimedia object database, therefore, the user can create multimedia object data individually and use it as inquiry object data. As a result, retrieval more suiting the user's preference can be conducted. In addition, if an external database can be used, then multimedia object data that can be browsed increase, and more multimedia object data similar to the multimedia object data to be retrieved can be browsed. Therefore, it becomes easy to retrieve a multimedia object requested by the user. Furthermore, in recent years, various multimedia object data are opened to the public on the Internet, and it has become possible for the user to freely browse these data via an Internet browser. At the time of browsing, a request for retrieving data similar to the multimedia object data that is being browsed often occurs. In such a case, it is possible to indicate that data by using an Internet address (URL). In the present first embodiment, it is possible to input the Internet address and thereby set it as the retrieval condition. Therefore, it becomes possible to set data that does not exist in the previously set multimedia object database as the retrieval condition. As a result, the degree of freedom in the retrieval condition setting increases, and it becomes possible to retrieve data that is more similar to the request.

As for the inquiry object in the retrieval condition setting, the user specifies a multimedia object that the user wants to retrieve, by perusing the multimedia object database. At that time, according to the present first embodiment, it is also possible to use a result of actually conducted retrieval, or a result obtained by rearranging the retrieval result according to the magnitude of features specified by the user. Since it is a retrieval result intended by the user or a result obtained by rearrangement according to the magnitude of the features specified by the user, the possibility that it has become an object that is suitable as the inquiry object is high. By setting as many high-ranking multimedia object data in the retrieval result or rearranged result as a preset number in the retrieval condition setting area 31, it becomes possible for the user to preset a further more suitable inquiry object more simply as compared with searching of the object list in the multimedia object database that has been arranged in a state in which there is no regularity. By the way, it is a matter of course that the object data list display area 32 may be also used for the retrieval result list display area.

[Second Embodiment]

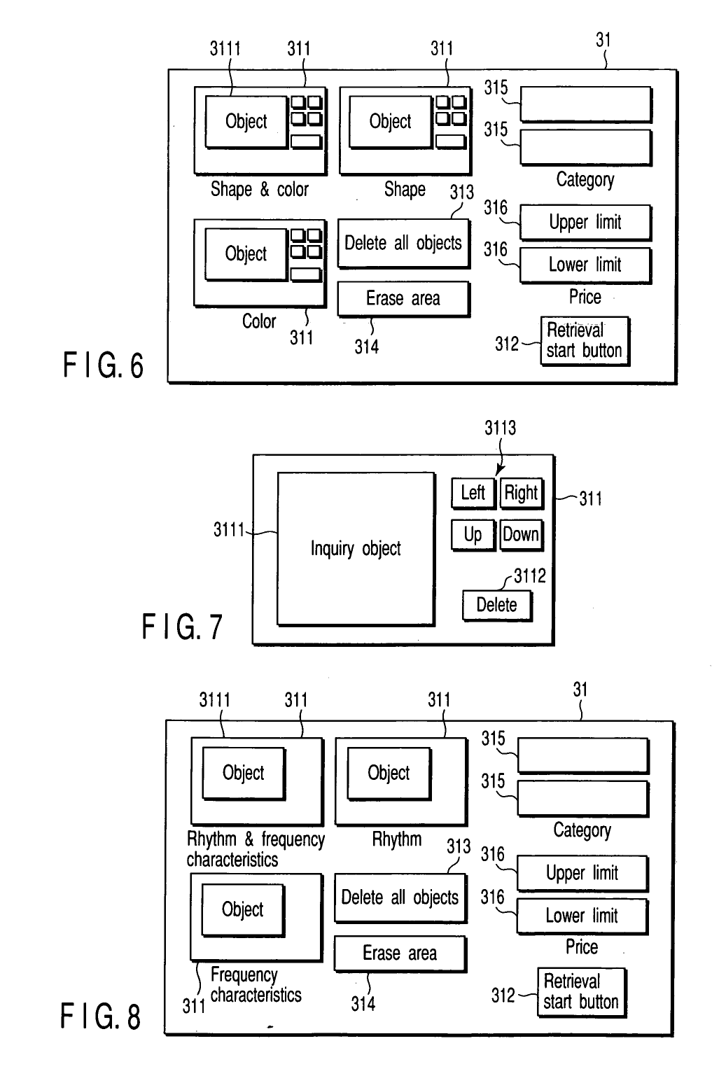

The present second embodiment is an example in the case where the multimedia object data to be retrieved is determined to be two-dimensional image data, three-dimensional image data, dynamic image data, video, or the like data. In other words, in the present embodiment, one or more inquiry object data display areas 311 for disposing an inquiry object 3111 therein are set in the retrieval condition setting area 31 as shown in FIG. 6. Different feature values can be set in the inquiry object data display areas 311, and it becomes possible to set the similar object retrieval condition, which is requested by the user, in detail. In the example shown in FIG. 6, setting using characteristics in shape and color of the multimedia object can be conducted. When an object has been selected from the object data list display area 32, the object is displayed in the inquiry object data display area 311 for “shape & color” in the initial state. The object set in the inquiry object data display area 311 for “shape & color” is set as a condition for retrieving multimedia objects that are similar in characteristics of both shape and color.

As shown in FIG. 7, a delete button 3112 is provided near each inquiry object 3111 in the same way as the first embodiment. In addition, control buttons (up, down, left and right movement buttons) 3113 for moving the inquiry object 3111 to another inquiry object data display area 311 is provided in the present embodiment. By clicking the control buttons 3113, the inquiry object 3111 can be moved to an inquiry object data display area 311 for “shape” or “color.” As for the object set in the inquiry object data display area 311 for “shape,” a retrieval condition that the shape is similar is set and retrieval is conducted. As for the object set in the inquiry object data display area 311 for “color,” a retrieval condition that a multimedia object that is similar in color is set and retrieval is conducted.

In this example, a “delete all objects” button 313 for deleting all inquiry objects 3111 and a “delete area” button 314 for erasing the retrieval condition setting area 31 itself from the display screen 30 are also disposed in the retrieval condition setting area 31. When a large number of inquiry objects 3111 are set, the inquiry objects 3111 can be deleted in the lump by clicking these buttons more simply than deleting individual inquiry objects 3111 one by one, resulting in a convenient function.

As for the retrieval condition, it is also possible to combine text information pieces that are set in respective multimedia objects. In other words, in the present embodiment, it is possible to narrow down the retrieval conditions in object category and price. As for the category, it is possible to specify an object category, such as a desk or a chair, and conduct retrieval. If as a specifying method an area specifying button (not shown) is clicked in a category specifying area 315, a list of categories which can be specified is displayed near the category specifying area 315. The user specifies a desired category from among the categories displayed in the list. A plurality of category specifying areas 315 are set, and it is also possible to specify a plurality of categories. As regards the price, for example, an upper limit and a lower limit of the price are set by using their specifying areas 316. At the time of retrieval, retrieval narrowed down to multimedia object data that are in the price range between the specified upper and lower limits is conducted. Besides, it is possible to set an arbitrary feature or attribute information such as the object magnitude or weight.

As a matter of course, multimedia object data to be retrieved may be audio data or music data, besides the two-dimensional image data, three-dimensional image data, dynamic image data, video data, or the like. In the case where audio data, music data, or the like is a subject of retrieval, the inquiry object data display areas 311 are provided for features such as “rhythm” and “frequency features” in the retrieval condition setting area 31 as shown in FIG. 8.

In this way, arbitrary feature values can be set in the retrieval condition setting area 31 according to multimedia object data to be retrieved. At this time, the inquiry object data display areas 311 for respective feature values can be arranged in an n by m matrix form (where n and m are arbitrary natural numbers). Although inquiry object data display areas 311 concerning a plurality of feature values are provided, weight coefficients and a combination concerning the feature values can also be set when setting a retrieval condition. As this setting method, they can be set by using an arbitrary logical expression. It is also possible to provide a user interface that can be set by the user.

In the case where the object data list display area 32 is used as the retrieval result list display area as described with reference to the first embodiment, it is possible to rearrange the retrieval results according to feature values specified by the user. In this case, a plurality of feature values can be set in the present embodiment. When rearrangement is performed with the set feature values specified, as many high-ranking object data in the rearranged result as a preset number are set in the corresponding inquiry object data display area 311.

As heretofore described, according to the present second embodiment, a plurality of inquiry object data display areas 311 are provided in the retrieval condition setting area 31 as features setting areas, and different features are set for respective inquiry object data display areas 311. When the retrieval condition is set as inquiry objects, therefore, not only simply a condition of similarity, but also in which viewpoint an object is similar to an inquiry object can be set in detail. Therefore, it becomes possible to conduct retrieval with the user's preference added to a greater degree. When there are a plurality of feature values setting areas, it is necessary to consider arrangement of feature values setting areas in the retrieval condition setting area 31. According to the present second embodiment, a retrieval condition setting area that is easy to see and easy to confirm the set retrieval condition is obtained owing to the arbitrary n by m matrix arrangement.

Furthermore, according to the present second embodiment, the combination of feature values can be altered in various ways, when setting the retrieval condition in the feature values setting areas (inquiry object data display areas 311), which are set as a plurality of areas in the retrieval condition setting area 31. The user can arbitrarily set the method of the combination.

For example, as in text data indicating a commodity category or the like of the multimedia object, some attribute information included in multimedia object data that is provided in text data can be grasped as a keyword. On the other hand, in general, the user aims at retrieval within some category in many cases, and object data in different categories are often unnecessary. According to the present second embodiment, therefore, a category is also specified previously as the retrieval condition in such a case, and consequently only multimedia object data in the specified category is retrieved. As a result, it becomes easy for the user to evaluate the retrieval result. In addition, since calculation of the degree of similarity can be conducted only in the category needed at the time of retrieval, it is advantageous in the sense of shortening in retrieval time as well.

[Third Embodiment]

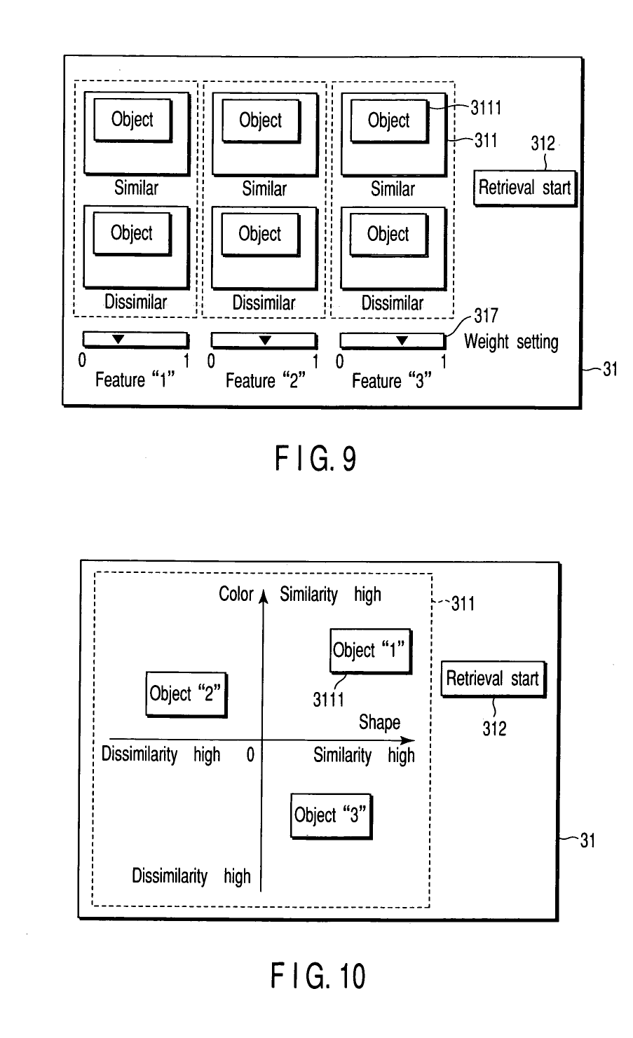

As shown in FIG. 9, inquiry object data display areas 311 respectively for “similar” and “dissimilar” are set for each of feature values set as feature values “1” to “3” in the retrieval condition setting area 31 in the present third embodiment. And the user sets and displays an object for which a similar multimedia object should be retrieved, in an upper “similar” inquiry object data display area 311. The user sets and displays an object that is not similar to an object that the user wants to retrieve, in a lower dissimilar inquiry object data display area 311. By doing so, retrieval condition setting can be conducted. In the present embodiment as well, the inquiry object data display areas 311 for the feature values can be arranged in an n by m (where n and m are arbitrary natural numbers) matrix form.

Furthermore, in the present embodiment as well, it is also possible to set weight coefficients and a combination concerning a plurality of feature values. As for its setting method, it is possible to set by using an arbitrary logical expression, and it is also possible to provide a user interface that can be set by the user. For example, in FIG. 9, user interfaces, such as sliders 317 displayed as “weight setting,” are provided to set weight coefficients for respective characteristics. Denoting the feature values “1” to “3” respectively by F₁ to F₃ and weight coefficients of feature values respectively by W₁ to W₃, and supposing that the combination is a logical sum given by a logical expression (W₁·F₁+W₂·F₂), feature values vectors (W₁·F₁, W₂·F₂) are compared. Supposing that the combination is a logical product given by a logical expression (W₁F₁*W₂·F₂), W₁ and W₂ are grasped as values corresponding to output numbers of the retrieval result. Retrieval result output numbers corresponding to W₁ and W₂ are set. With respect to outputs resulting from retrieval first conducted by using only F₁, retrieval using F₂ is conducted. Such a method can be set.

In the case where the object data list display area 32 is used as a retrieval result list display area, it is possible to rearrange the retrieval result according to feature values specified by the user, as described with the first embodiment. In this case, in the present third embodiment, a plurality of feature can be set in the retrieval condition setting area 31. When rearrangement is performed with the set feature values specified, as many high-ranking object data in the rearranged result as a preset number are set in the corresponding inquiry object data display area 311.

As heretofore described, according to the present third embodiment, it is made possible to set a condition that is dissimilar independently for the selected objects. In the case where similar object retrieval is conducted, multimedia objects similar to a multimedia object to be retrieved are typically set as inquiry objects. On the contrary, there is a desire to retrieve a multimedia object that is dissimilar to the multimedia object to be retrieved. In order to cope with such a request, according to the present embodiment, it is possible to take the user's preference in the retrieval condition to a greater degree by providing dissimilar condition setting areas. When there are a plurality of feature values setting areas (inquiry object data display areas 311), it is necessary to consider the arrangement of the characteristic setting areas in the retrieval condition setting area 31. According to the present embodiment, however, it is possible to obtain a retrieval condition setting area that is easy to see and easy to confirm the set retrieval conditions owing to arrangement of the arbitrary n by m matrix form. In addition, since “similar” and “dissimilar” make a pair, “similar” or “dissimilar” setting is facilitated by disposing “similar” and “dissimilar” so as to be adjacent to each other.

Furthermore, according to the present third embodiment, the combination of feature values can be altered in various ways, when setting the retrieval condition in the feature values setting areas (inquiry object data display areas 311), which are set as a plurality of areas in the retrieval condition setting area 31. The user can arbitrarily set the combination method.

[Fourth Embodiment]

The present fourth embodiment is an example in the case where the multimedia object data to be retrieved is determined to be two-dimensional image data, three-dimensional image data, dynamic image data, video data, or the like. In the present fourth embodiment, the retrieval condition setting area 31 is set as a coordinate system as shown in FIG. 10. A two-dimensional coordinate position can be represented by a position in which an inquiry object 3111 is set. In the present embodiment, “shape” is set on the abscissa axis and “color” is set on the ordinate axis. The magnitude of coordinates is determined by the position in which an inquiry object 311 is set. Weight coefficients for respective feature values are set by magnitudes of the shape coordinate and the color coordinate. In the case where this setting method is used, it is possible to conduct setting so as to make the coordinate value negative as in the inquiry objects 3111 of the object “2” and the object “3” shown in FIG. 10. In such a case, the magnitude of the coordinate means the magnitude of dissimilarity.

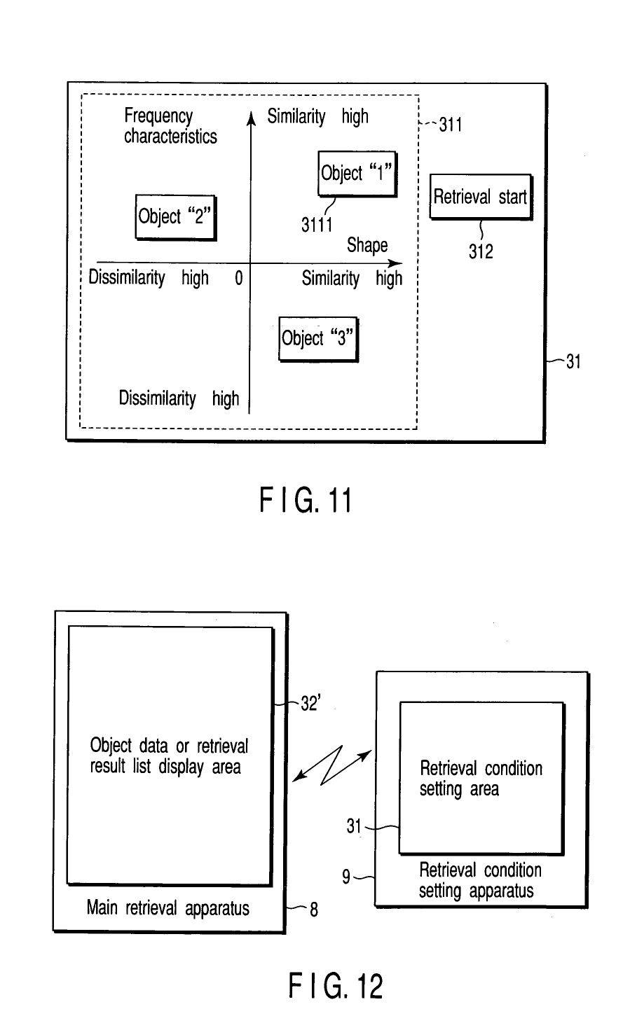

As a matter of course, multimedia object data to be retrieved may be audio data, music data, or the like, besides the two-dimensional image data, three-dimensional image data, dynamic image data, video data, or the like. In the case where audio data, music data, or the like is a subject of retrieval, the retrieval condition setting area 31 is provided as a coordinate system having “rhythm” set on the abscissa axis and “frequency features” set on the ordinate axis as shown in FIG. 11.

As heretofore described, according to the present fourth embodiment, it is possible to give coordinate values according to a position in which an inquiry object is set in the retrieval condition setting area 31. The coordinate value can be set as a weight coefficient for feature values set by the coordinate. As a result, it is easy to grasp the set retrieval condition visually.

[Fifth Embodiment]

In the present fifth embodiment, a main retrieval apparatus 8 for displaying an object data or retrieval result list display area 321 and conducting an actual retrieval operation and a retrieval condition setting apparatus 9 for displaying a retrieval condition setting area 31 are separated as independent hardware apparatuses. In other words, it is possible for the user to own only the retrieval condition setting apparatus 9 and conduct the retrieval condition setting. Connection between the main retrieval apparatus 8 and the retrieval condition setting apparatus 9 can be implemented by using an arbitrary method, such as connection using a connection cable, wireless connection using a radio wave, infrared light, or the like, or network connection.

In this way, the main retrieval apparatus 8 and the retrieval condition setting apparatus 9 are separated from each other. Even if the user is away from the main retrieval apparatus 8, therefore, the user can conduct the retrieval operation, provided that the user has only the retrieval condition setting apparatus 9. As a result, the range in which the retrieval operation can be conducted is expanded. It becomes possible to set inquiry objects as the retrieval condition from a wide area, and it becomes possible to conduct retrieval of an object more similar to the object requested by the user.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A method for setting a retrieval condition when retrieving similar multimedia object data from a multimedia object database on the basis of the retrieval condition set by a user, the method comprising:
displaying a retrieval condition setting area for retrieval condition setting as an independent area; and
setting a retrieval condition on the basis of one of multimedia object data which has been set in the retrieval condition setting area and multimedia object data which has been input to the retrieval condition setting area.

2. The method according to claim 1, wherein the multimedia object data which has been set in the retrieval condition setting area comprises one of: inquiry object data which has been set as a retrieval condition; and one of an image and item associated with inquiry object data.

3. The method according to claim 1, further comprising:
displaying an object data list display area for displaying images associated with respective data in the multimedia object database, wherein
by selecting at least one multimedia object data from the object data list display area, the selected multimedia object data is displayed in the retrieval condition setting area and a retrieval condition is set.

4. The method according to claim 3, wherein
in response to operation of a control button for setting object data into the retrieval condition setting area, disposed near one of an image and item associated with original multimedia object data in the object data list display area, the original multimedia object data is displayed in the retrieval condition setting area and a retrieval condition is set.

5. The method according to claim 3, wherein
in response to direct specification of one of an image and item associated with original multimedia object data in the object data list display area, the original multimedia object data is displayed in the retrieval condition setting area and a retrieval condition is set.

6. The method according to claim 3, wherein
in response to operation of a pointing device to specify one of an image and item associated with original multimedia object data in the object data list display area and move it onto the retrieval condition setting area, the original multimedia object data is displayed in the retrieval condition setting area and a retrieval condition is set.

7. The method according to claim 2, wherein
the inquiry object data is set in the retrieval condition setting area by one of:
inputting it via an external object data input unit connected to a retrieval apparatus to which the method according to claim 2 is applied;
selecting it from an external database; and
taking in an object data file owned by the user.

8. The method according to claim 2, wherein
the inquiry object data is set in the retrieval condition setting area by inputting multimedia object specified by an Internet address specified by the user.

9. The method according to claim 1, wherein
the retrieval condition is set according to a plurality of feature values calculated from a multimedia object,
the retrieval condition setting area has a plurality of feature setting areas, and
the feature setting areas are assigned feature kinds which are set according to one of: the feature values; and a combination of the feature values.

10. The method according to claim 9, wherein
the feature setting areas are arranged and displayed in an n by m (where n and m are natural numbers) matrix form in the retrieval condition setting area.

11. The method according to claim 1, wherein
the retrieval condition setting area comprises a dissimilar feature setting area for setting a dissimilarity condition independently for each of selected objects.

12. The method according to claim 11, wherein
for each of feature values, similar and dissimilar feature setting areas are provided as an adjacent pair, and
a plurality of pairs are arranged in an n by m (where n and m are natural numbers) matrix form.

13. The method according to claim 9, wherein
the retrieval condition is set according to a combination of feature values which have been set in respective feature setting areas provided in the retrieval condition setting area, and
a method of the combination is set by the user.

14. The method according to claim 9, wherein
inquiry object data is set and disposed in an arbitrary position in the retrieval condition setting area, and
a weight of set feature values is set according to a position in which the inquiry object data is set and disposed.

15. The method according to claim 1, wherein
at the time of retrieval condition setting, attribute information owned by a multimedia object is set as a keyword in combination.

16. The method according to claim 1, wherein
a result of retrieval conducted by using the retrieval condition which has been set is displayed in a list form in a retrieval result list display area, on the basis of one of: an order of similarity; and an order of a result of rearrangement when the user has conducted a rearrangement operation on the retrieval result, and
a retrieval condition is set by one of: displaying as many high-ranking multimedia object data as a preset number in the retrieval condition setting area on the basis of an order of display; and selecting at least one multimedia object data from the retrieval result list display area and displaying the at least one multimedia object data in the retrieval condition setting area.

17. The method according to claim 1, wherein
the retrieval condition setting area is displayed in a display screen of a display device which is independent in hardware from an apparatus for executing actual retrieval.

18. An apparatus for setting a retrieval condition when retrieving similar multimedia object data from various multimedia object databases on the basis of the retrieval condition set by a user, the apparatus comprising:
a display device having a display screen in which a retrieval condition setting area for retrieval condition setting is displayed as an independent area;
an input unit configured to one of set and input multimedia object data in and to the retrieval condition setting area displayed on the display screen of the display device; and
a retrieval condition setting unit configured to set a retrieval condition on the basis of multimedia object data one of set in and input to the retrieval condition setting area by the input unit.

19. An apparatus for setting a retrieval condition when retrieving similar multimedia object data from various multimedia object databases on the basis of the retrieval condition set by a user, the apparatus comprising:
a display device having a display screen in which a retrieval condition setting area for retrieval condition setting is displayed as an independent area;
input means for one of setting and inputting multimedia object data in and to the retrieval condition setting area displayed on the display screen of the display device; and
retrieval condition setting means for setting a retrieval condition on the basis of multimedia object data one of set in and input to the retrieval condition setting area by the input means.
